(19) United States
(12) Patent Application Publication
(10) Pub. No.: US 2025/0334463 A1
(43) Pub. Date: Oct. 30, 2025

(54) TORQUE MEASUREMENT DEVICE USING LINEAR DISPLACEMENT

(71) Applicant: Tri-Tec Manufacturing, LLC, Kent, WA (US)

(72) Inventors: Andrew Robert Ales, Kent, WA (US); Mark Scott Soldan, Kent, WA (US)

(73) Assignee: Tri-Tec Manufacturing, LLC, Kent, WA (US)

(21) Appl. No.: 18/907,333

(22) Filed: Oct. 4, 2024

Related U.S. Application Data
(60) Provisional application No. 63/592,522, filed on Oct. 23, 2023.

(51) Int. Cl. G01L 3/14; F16K 31/04

(52) U.S. Cl. CPC G01L 3/1464; F16K 31/04; G01L 3/145; G01L 3/1492

(57) ABSTRACT

A device for a valve actuator directed to measuring torque through linear displacement of a driving member is provided. The device comprises a valve actuator that includes an actuator motor and a driving member having a first end and a second end. A screw is coupled to the driving member and positioned between the first end and the second end. A gear configured to engage against the screw is positioned adjacent to the driving member. A spring element having a known constant is coupled to the second end of the driving member. The device further includes a linear potentiometer or a microswitch, and a method for measuring torque using the provided linear potentiometer or microswitch.

### STATEMENT OF GOVERNMENT INTEREST

This invention was made with government support under N64498-21-9-0001 awarded by U.S. Department of Defense The government has certain rights in the invention.

### BACKGROUND

### Technical Field

The present disclosure relates to both linear potentiometer devices and a microswitch devices used for measuring the torque of an electronic actuator. A method to limit or measure output torque using the linear potentiometer device or the microswitch device is also provided.

### Description of the Related Art

In fluid transfer applications, valve actuators are routinely used to operate valves, and therefore essentially rely on power, or torque, in order to open and/or close valves. Establishing the specific amount of torque required aids in accurately determining valve actuator specifications and proper valve positioning. The ability to accurately measure the amount of torque required to open or close valves is beneficial in order to avoid over torquing of the valve which may cause severe leaks, stem deformation, interrupt essential operations of the fluid transfer, or permanently damage the valve. There are existing methods of measuring torque that rely on microprocessors, however, in some cases the ability to utilize microprocessors in some environments is not ideal.

In current designs, measuring the torque of a rotating system is currently limited to a few methods, such as motor-based methods and reaction sensor methods. Motor-based methods, which determine system torque form the motor current, only function while the motor is energized and require a microprocessor to produce the desired information. Additionally, motor-based methods may be applicable for alternating current (AC) induction motors, however the method is more complicated than using direct current (DC) motors. Furthermore, with both AC and DC motors, poor power quality (i.e., dirty electricity) used to power the entire system can also make this method more complicated and unreliable. Reaction sensor methods employ a strain gauge or load-cell mechanism located in the drive train between the motor and the housing, or between the actuator/device and its mating component. These sensors are large, expensive, and are dependent on the use of microprocessors. While other methods and devices are used in current designs to measure torque, those methods are not continuous, or the devices used may be too large or cumbersome to provide accurate torque measurement.

### BRIEF SUMMARY

A mechanical system and method that encompasses a smaller, low cost, and flexible design, while maintaining the ability to provide robust feedback that is not reliant on the state of the motor is provided. Embodiments of the present disclosure provide for a torque measurement device that utilizes an internal worm drive of the valve actuator to determine a torque applied at an output of the valve actuator, allowing for a reaction based on control parameters to avoid or reduce over torquing and under torquing. The capability of the valve actuator to react based on control parameters is critical because some valves are determined to be closed or seated based on the position of its closing member. Others are ideally determined to be closed when the torque or force applied to the closing member reaches a predetermined value. Embodiments of the torque measurement device may include a linear potentiometer or a microswitch.

An embodiment of a device may be summarized as including: a valve actuator that includes an actuator motor, a driving member having a first end opposite to a second end, with the first end coupled to the actuator motor; a worm drive that includes a screw pivotally mounted onto the drive member; a gear coupled to the screw; a spring element coupled to the second end of the driving member; and a linear potentiometer coupled to the spring element and to the second end of the driving member. The worm drive may be configured to create a linear force to the driving member. The spring element may be configured having a spring constant and the driving member may be configured to compress the spring element with the linear force from the worm drive.

The device may also include a plunger that is internally housed within the linear potentiometer and spring element, and the plunger extending between the linear potentiometer and the spring element into the second end of the driving member and configured to change resistance for the driving member. The linear potentiometer may be configured having a specified resistance that changes with a movement of the driving member. The linear potentiometer may be configured to measure and compare the movement of the driving member against the spring constant. The linear potentiometer may be configured to determine an output torque from the valve actuator that is applied on the driving member in response to the movement of the driving member against the spring constant.

The device may also include a housing that substantially encloses the valve actuator. The device may include one or more supports that are coupled to the housing, and/or one or more supports are coupled to the driving member. The screw may be fixedly mounted onto the drive member.

Another embodiment of the device may be summarized as including: a valve actuator; an actuator motor housed in the valve actuator; a driving member having a first end and a second end, the first end being opposite to the second with the first end being coupled to the actuator motor; a worm drive that includes a screw that is mounted onto the driving member and rotatably engaged against a gear; and spring element having a known constant mounted around a portion of the driving member, wherein the driving member compresses the spring element; a spring pre-loaded plate; a screw coupled to the spring pre-loaded plate; a switch plate with the spring pre-loaded plate being between the screw and the switch plate; and an electrical switch coupled to the switch plate.

The spring pre-loaded plate may abut against the spring elements and may be configured to have a known value. The device may further include one or more supports, wherein at least one of the supports is a spring reaction support. The screw may extend through the spring pre-loaded plate and the spring element, with the screw having a first end traverse to the spring reaction support, and with a second end parallel to the second end of the driving member. The electrical switch may include at least one wire coupled between the spring element and the switch plate, and the electrical switch may be configured to detect the linear force applied to the switch plate by compression of the spring element wherein the linear force exceeds the known value of the spring pre-loaded plate, and an output torque is determined and activates the electrical switch.

A method of detecting torque measurement of a valve actuator may be summarized as including: producing a linear force on a driving member by applying force from a worm drive; measuring the linear force of the driving member with a measurement system; and determining a torque output of the valve actuator by comparing the linear force from the worm drive with a spring constant of the spring element. The method may further include a linear potentiometer that is configured to determine the torque output. The method may further include a microswitch that is configured to determine the torque output.

### BRIEF DESCRIPTION OF THE SEVERAL VIEWS OF THE DRAWINGS

FIG. 1 illustrates a perspective view of a housing for a valve actuator having an embodiment of a torque measurement device.

FIG. 2 illustrates a perspective view of the housing of FIG. 1 with an upper portion of the housing removed.

FIG. 3 illustrates a top view of a gear in an embodiment of the torque measurement device.

FIG. 4 illustrates a cross-sectional view of an embodiment of a torque measurement device having a linear potentiometer.

FIG. 5 illustrates a cross-sectional view of an embodiment of a torque measurement device having a microswitch.

FIG. 6 illustrates a perspective view of the torque measurement device of FIG. 5.

FIG. 7 illustrates a top perspective view of an embodiment of a torque measurement device.

### DETAILED DESCRIPTION

In the following description, certain specific details are set forth in order to provide a thorough understanding of various disclosed embodiments. However, one skilled in the relevant art will recognize that embodiments may be practiced without one or more of these specific details. In other stances, well-known devices, structures, and techniques associated with the operation of valve actuators may not be shown or described in detail to avoid unnecessarily obscuring descriptions of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The present disclosure achieves direct measurement of torque in a system's gear train combined with multiple methods for reading, and acting on, the torque information. Utilizing existing essential components in the system, this method significantly reduces the size and complexity of the equipment. Additionally, simple mechanical systems described herein provide for robust feedback that is not reliant on the state of the motor, while maintaining an unobtrusive configuration and design.

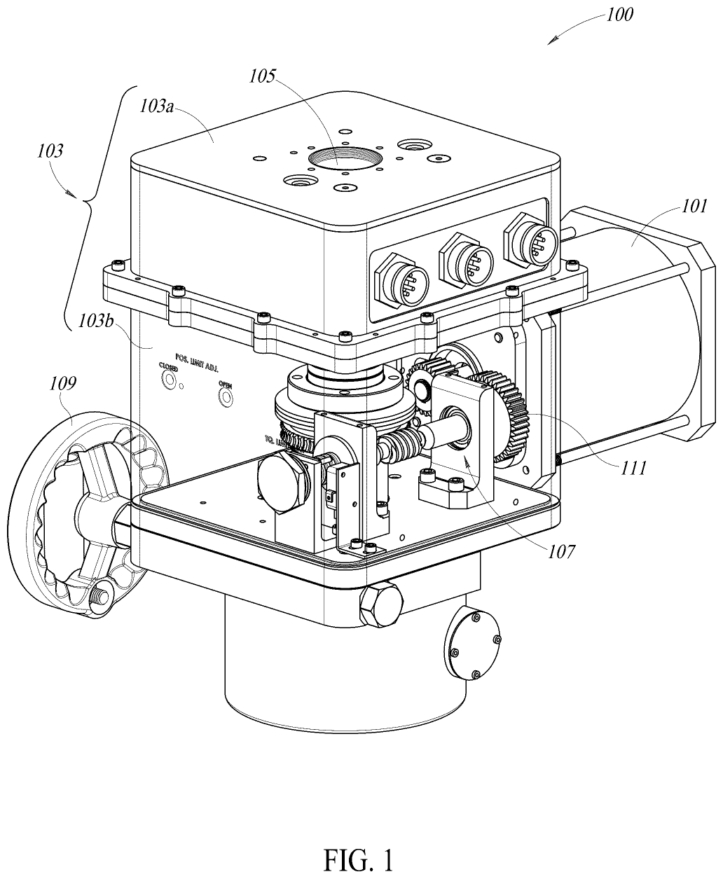

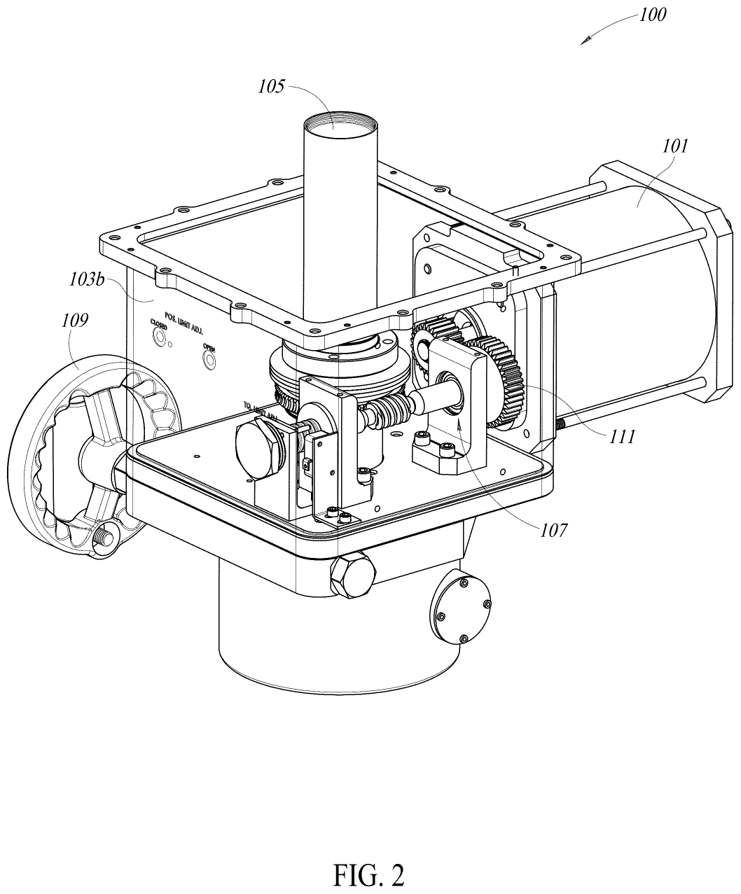

FIGS. 1 and 2 illustrate a valve actuator 100 having a housing 103 that encloses an example embodiment of a torque measurement device 107, which will be described in greater detail below. FIGS. 1 and 2 encompass many of the same features and elements. The housing 103 includes a top portion 103a and a bottom portion 103b that are coupled together by a plurality of fasteners. The top portion 103a of the housing 103 includes features and elements that are typically found in the relevant art. The bottom portion 103b of the housing 103 is illustrated in a transparent manner in order to show the non-intrusive and efficient configuration of the example embodiment of the torque measurement device 107 within the confines of the housing 103.

The housing 103 including the top and bottom portions 103a, 103b are substantially rectangular shaped, but may encompass other configurations suitable for housing the valve actuator 100. An actuator motor 101 is positioned on one side of the housing 103. The actuator motor 101 is coupled to interlocking gears 111 that generate movement and power to the torque measurement device 107. The housing 103, actuator motor 101, and interlocking gears 111 are not limited to the design and configuration as shown in FIGS. 1 and 2 but may be other rotary equipment capable of generating movement of the valve. The bottom portion 103b includes a handwheel 109 that is coupled to a side of the housing 103. The handwheel 109 is configured to manually generate torque or movement to operate the valve in scenarios when power operation of the valve actuator 100 is limited or inoperable, or in other situations deemed necessary by the user. FIG. 2 further illustrates the valve actuator 100 with the top portion 103a of the housing 103 removed. A stem cover 105 extends out the top of the valve actuator 100 where the stem may indicate the positioning of the valve to the user. For clarity purposes, the valve and stem are not shown in the figures.

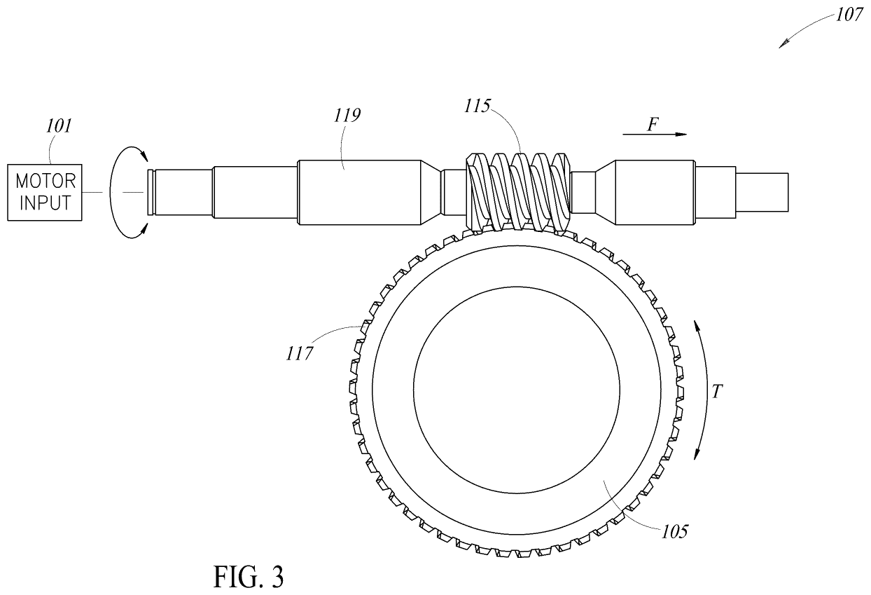

FIG. 3 illustrates a top view of a portion of the torque measurement device 107 shown in FIGS. 1 and 2. The torque measurement device 107 includes a driving shaft or driving member 119 that is driven and rotated by the actuator motor 101. The driving member 119 includes a screw 115 that is coupled to a portion of the driving member 119. The screw 115 may be coupled to the driving member 119 in various configurations based on factors such as the valve actuator size, the torque measurement device 107 size or configuration in relation to the housing, and other factors determined by the user or manufacturer.

The screw 115 coupled to the driving member 119 engages with a gear 117, which could be a worm gear, and collectively forms a worm drive. The gear 117 is positioned adjacent to the driving member 119 and includes projections or teeth that allows the gear 117 to mesh and engage with the screw 115. When the actuator motor 101 is energized, the motor causes the driving member 119 to rotate. As the driving member 119 rotates, the screw 115 and gear 117 engage, transmitting force to the driving member 119.

An actuator output 105 contributes to a derived torque T amount that rotates the gear 117. Consequently, the derived torque T from the gear 117 leads to a corresponding linear force F on the driving member 119. The linear force F generated is then counteracted by a spring element or semi-rigid support, which will provide a finite and measurable linear displacement. Once the linear displacement is determined, multiple methods may be used to correlate the linear displacement to the output torque. These methods include the use of a linear potentiometer torque measurement device 200 and/or a microswitch torque measurement device 300.

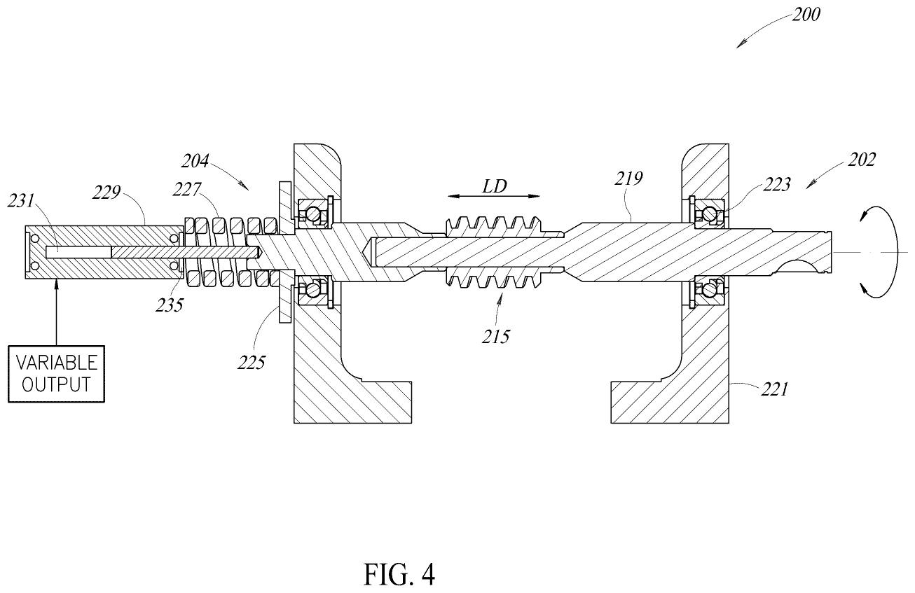

FIG. 4 illustrates a cross-sectional view of the linear potentiometer torque measurement device or linear potentiometer device 200. Linear potentiometers function as position sensors and help measure displacement along a linear path. In this embodiment of the present disclosure, the linear potentiometer device 200 measures the linear displacement of the gear or shaft against a spring to provide feedback and calculate the amount of torque applied.

The linear potentiometer device 200 includes a driving shaft or member 219 having a first end 202, and a second end 204 opposite to the first end 202. The first end 202 of the driving member 219 is coupled to an actuator motor 101, as described and illustrated in FIGS. 1 and 2. The driving member 219 includes a screw 215 that is centrally positioned along the driving member 219 and configured to mesh and/or engage with the gear 117, as described and illustrated in FIG. 3. In some embodiments, the screw 215 is integrally formed within the driving member 219, such as welded or pressed together. In FIG. 4, there is a line illustrated that separates the screw 215 from the driving member. As noted above, these may be a single element.

The screw 215 is positioned between one or more support members 221 that are coupled to the driving member 219 and help stabilize the linear potentiometer device 200 during operation. The one or more support members 221 also enable the linear potentiometer device 200 the flexibility to be placed in various convenient locations in the valve actuator 100. The one or more supports 221 are each configured with a plurality of ball bearings 223 that are placed surrounding the driving member 219 to reduce friction and protect the driving member 219 as it operates. The driving member 219 can translate relative to the one or more supports 221. There may be a small space or gap between walls of the driving member 219 and the one or more supports 221 to allow for effective, efficient rotation.

A spiral spring or spring element 227 is positioned at the second end 204 of the driving member 219, opposite to the first end 202 that is coupled to the actuator motor 101. The spring element 227 surrounds a portion of the second end 204 of the driving member 219. The spring element 227 is configured to apply a semi-rigid support and counteract the linear force F generated by the gear 117, providing a finite and measurable linear displacement LD. The spring element 227 is positioned along the end of the driving member 219 such that the spring element 227 abuts a thrust bearing 225. The thrust bearing 225 is interposed between the spring element 227 and the support member 221. The thrust bearing 225 is arranged closer to the second end 204 than the first end 202, and substantially surrounds a portion of the driving member 219 at the second end 204. The thrust bearing 227 supports the axial thrust of the driving member 219 against the spring element 227 and prevents the driving member 219 from drifting in the axial direction.

The spring element 227 is configured on the linear potentiometer device 200 having a known spring constant. In operation, the gear 117 engages against the screw 215 resulting in the linear force F being applied on the driving member 219. The linear force F on the driving member 219 pushes against the spring element 227 having the known spring constant. As the driving member 219 compresses the spring element 227, the linear force F required equals the spring constant multiplied by Delta X (not shown). For example, if the linear force F generated by the gear 117 displaces the spring constant, then a linear displacement LD is now known due to the amount of force that was required.

The linear potentiometer device 200 further includes a linear potentiometer 229 that is adjacent to the spring element 227 and positioned at the second end 204 of the driving member 219. The linear potentiometer 229 is configured to measure the linear displacement LD along a single axis, for example, the driving member 219. In some embodiments, the linear potentiometer 229 may be a rotary potentiometer and a lever or cam member, so long as the potentiometer is configured to react to the linear displacement LD. A connection or fastening element 235 couples the linear potentiometer 229 to the spring element 227. An internal rod or plunger 231 is embedded in the linear potentiometer 229 and configured to move in a linear direction within the linear potentiometer device 200. The plunger 231 extends from the linear potentiometer 229 through both the fastening element 235 and the spring element 227, into the second end 204 of the driving member 219.

The linear potentiometer 229 is positioned on the linear potentiometer device 200 in a manner that allows the linear potentiometer 229 to read the movement of the driving member 219. For example, the resistance of the linear potentiometer 229 changes as the driving member 219 and plunger 231 moves. The measured resistance of the spring element 227 determines Delta X, which is multiplied by the known spring constant to determine the required force on the driving member 219 and subsequently, a torque measurement.

In some embodiments, a microprocessor may be required because the linear potentiometer 229 output is resistance, thus requiring some amount of calculation to accurately determine the reaction force and torque. However, in some embodiments, determining torque measurement through calculation of linear displacement LD of the driving member may be achieved without a microprocessor. This may be accomplished by requiring analog circuitry in the linear potentiometer. The resistance value in the linear potentiometer will manually change (i.e., behave as a switch), such that if the resistance in the linear potentiometer exceeds a certain value, the circuit that is connected to the linear potentiometer will either open or close.

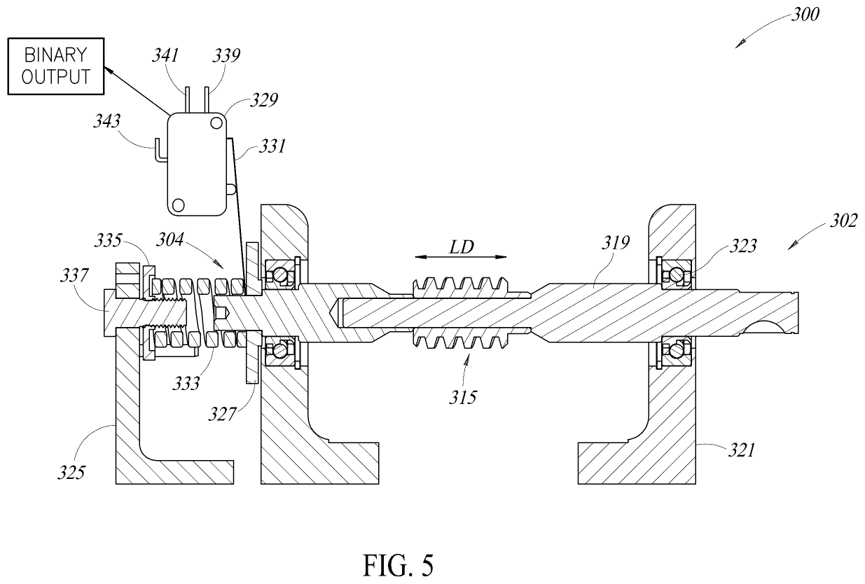

FIG. 5 illustrates a cross-sectional view of a microswitch torque measurement device or microswitch measurement device 300. Similar to the torque measurement method described earlier, the microswitch measurement device 300 is configured in the valve actuator 100 to measure the linear displacement of the gear or shaft against a spring to provide feedback and calculate the amount of torque applied.

The microswitch measurement device 300 includes a driving shaft or member 319 having a first end 302 and a second end 304 opposite to the first end 302. The first end 302 of the driving member 319 is coupled to the actuator motor 101. A screw 315 is arranged along the driving member 319 and positioned between one or more support members 321. The one or more support members 321 are each configured with a plurality of ball bearings 323 that surround a portion of the driving member 319 on each respective support member 321.

A spiral spring or spring element 333 is coupled to the second end 304 of the driving member. The spring element 333 surrounds a portion of the second end 304 and has one side that abuts a switch plate 327 that borders directly on one of the support members 321. The switch plate 327 is situated on a side of the support member 321 that is closer to the spring element 333 than to the screw 315. The switch plate 327 is configured with the capability of moving with the linear displacement LD and operates in conjunction with the spring element 333. The spring element 333 is arranged between one support member 321 and a spring reaction support member 325. The spring reaction support member 325 encourages the ability of the driving member 319 to react by the spring element 333 and float linearly.

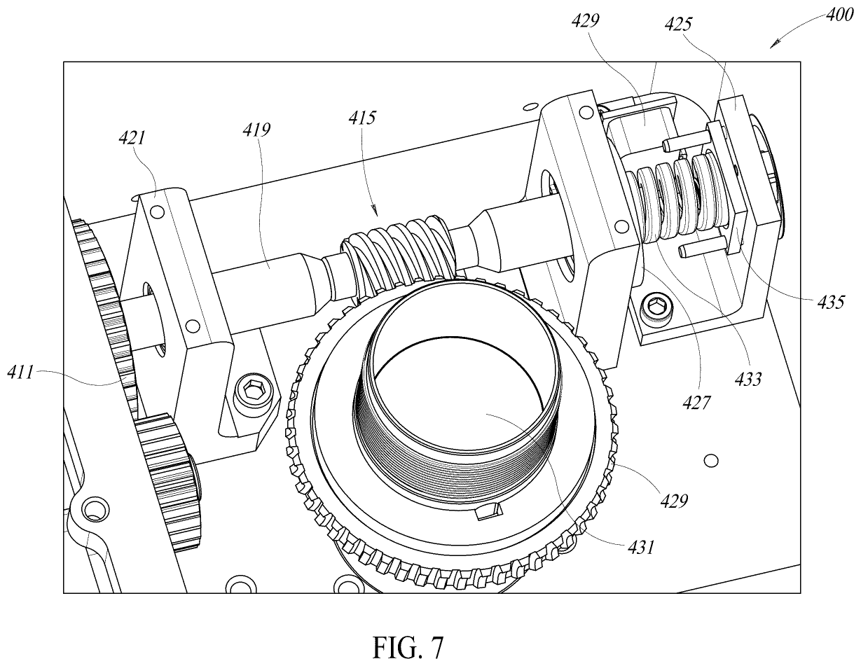

A second side of the spring element 333 is configured to seat within a portion of a spring preload plate 335. The spring preload plate 335 partially surrounds the end of the spring element 333 and is arranged between the spring reaction support member 325 and the support member 321, with the spring preload plate 335 closer to the spring reaction support member 325 than the one or more support member 321. A screw 337 is screwed or inserted into the spring reaction support member 325, essentially coupling the spring element 333 to the spring preload plate 335 and spring reaction support member 325. Although a spring tension set point is primarily set during manufacture to the required torque amount, that setting can be changed in-situ by using the screw 337 and spring preload plate 335 described herein. For example, in some embodiments, the screw 337 may be accessible through a hole or aperture in a housing of the actuator (partially shown in FIG. 7) that allows for the spring element 333 to be pre-loaded to a known value or constant. If the need to adjust the amount of torque a valve can apply arises at a given time, the user can advantageously go through the opening of the housing and adjust the preload accordingly.

When readjustment of the spring tension set point is needed, the screw 337 may be adjusted such that the spring preload plate 335 will compress or relax the spring element 333. Because the spring element 333 has a known constant, the amount of constant exerted tension applied to the switch plate 327 and driving member 319 from the spring element 333 is easily determinable. If the linear force F on the driving member 319 exceeds the spring tension set point, the driving member 319 can move linearly (i.e., compress the spring element 333 further) causing movement of the switch plate 327 and activating an electrical switch or microswitch 329.

The microswitch 329 includes three connection points such as a common line 343, a normally open line 341, and a normally closed line 339. However, it is appreciated that the microswitch 329 may be configured in a manner preferable by the user and/or manufacturer. The microswitch 329 further includes a lever 331 used to open or close internal contacts within the microswitch 329. Once energized or activated, the microswitch 329 provides a signal to an analog system to turn off the actuator motor 101, or other situations another command deemed necessary. The microswitch 329 may or may not include some bracketry, however it is appreciated that the microswitch 329 may be mounted on any location within the general area of the microswitch measurement device 300, so long as the microswitch 329 can appropriately react from the switch plate 327 pressing against the lever 331.

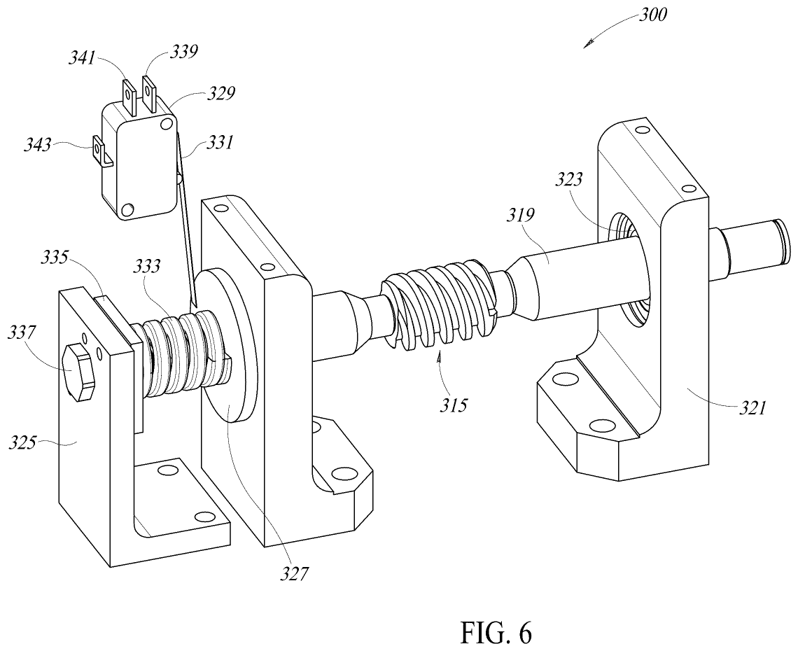

Both the linear potentiometer torque measurement device 200 and microswitch torque measurement device 300 employ an unobtrusive configuration. The linear potentiometer measurement and microswitch measurement devices 200, 300 are capable of being arranged and adjusted without disrupting critical operations, such as having to open up massive side panels, etc. For example, the unobtrusive configuration of the torque measurement devices 200, 300 allow for a user, if needed, to insert a tool, turn a screw, and achieve the desired readjustment. To further illustrate an alternative visual perspective of the embodiment, FIG. 6 shows a perspective view of the microswitch torque measurement device 300 comprising the microswitch 329 as shown in FIG. 5.

FIG. 7 illustrates a microswitch torque measurement device 400 having a general structure similar to the microswitch torque measurement device 300 of FIGS. 5 and 6, such as the microswitch measurement device 400 having a driving shaft or member 419 driven by motor gears 411 and coupled to a spring reaction support member 425 and one or more supports 421. FIG. 7 shows the support members 425, 421 coupled to the housing as similarly shown in FIGS. 1 and 2. However, in some embodiments the support members 425,421 may be configured in the valve actuator housing in an alternative manner. A screw 415 is arranged along the driving member 419 and configured to mesh or engage against a gear 429 of an actuator output 431. In this embodiment, the screw 415 is slid onto a beveled portion of the driving member 419, but may be fastened to the driving member 419 in an alternative fashion. The screw 415 and driving member 419 may be a single piece once welded together. The microswitch device 400 further includes a switch plate 427, a spring element 433, and spring preload plate 435. Similar to the embodiment in FIG. 5, a screw is inserted through the spring reaction support member 425 to couple the spring element 433 and spring preload plate 435, and is easily accessible through an aperture or hole in the housing. An electrical switch or microswitch 429 is shown coupled to the microswitch device 400 and is configured to operate in a similar manner as the microswitch 329 shown in FIGS. 5 and 6, for example, the microswitch 429 activating at a fixed amount of linear displacement against the spring element 433, subsequently providing feedback that a specific torque value has been reached.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

1. A device, comprising:
a valve actuator that includes:
an actuator motor;
a driving member having a first end opposite a second end, the first end coupled to the actuator motor;
a worm drive that includes:
a screw pivotally mounted onto the drive member;
a gear coupled to the screw;
a spring element coupled to the second end of the driving member; and
a linear potentiometer coupled to the spring element and to the second end of the driving member.

2. The device of claim 1 wherein the worm drive is configured to create a linear force to the driving member.

3. The device of claim 2 wherein the spring element is configured having a spring constant and the driving member is configured to compress the spring element with the linear force from the worm drive.

4. The device of claim 1 further comprising an analog circuit coupled to the linear potentiometer.

5. The device of claim 1 further comprising a plunger internally housed within the linear potentiometer and spring element, the plunger extending between the linear potentiometer and the spring element into the second end of the driving member and configured to change resistance of the driving member.

6. The device of claim 1, wherein the linear potentiometer is configured having a specified resistance that changes with a movement of the driving member.

7. The device of claim 1, wherein the linear potentiometer is configured to measure and compare the movement of the driving member against the spring constant.

8. The device of claim 1, wherein the linear potentiometer is configured to determine an output torque from the valve actuator applied on the driving member in response to the movement of the driving member against the spring constant.

9. The device of claim 1 further comprising a housing that substantially encloses the valve actuator.

10. The device of claim 9 further comprising one or more supports coupled to the housing.

11. The device of claim 10, wherein the one or more supports are coupled to the driving member.

12. The device of claim 11 wherein the screw is fixedly mounted onto the driving member.

13. A device, comprising:
a valve actuator;
an actuator motor housed in the valve actuator;
a driving member having a first end and a second end, the first end opposite to the second end with the first end coupled to the actuator motor;
a worm drive that includes a screw mounted onto the driving member and rotatably engaged against a gear;
a spring element having a known constant mounted around a portion of the driving member, wherein the driving member compresses the spring element;
a spring pre-loaded plate;
a screw coupled to the spring pre-loaded plate;
a switch plate, the spring pre-loaded plate being between the screw and the switch plate; and
an electrical switch coupled to the switch plate.

14. The device of claim 13 wherein the spring pre-loaded plate abuts against the spring elements and is configured to have a known value.

15. The device of claim 13 further comprising one or more supports, wherein at least one support is a spring reaction support.

16. The device of claim 13 wherein the screw extends through the spring pre-loaded plate and the spring element, the screw having a first end traverse to the spring reaction support, and a second end parallel to the second end of the driving member.

17. The device of claim 13 wherein the electrical switch includes:
at least one wire coupled between the spring element and the switch plate, the electrical switch configured to detect the linear force applied to the switch plate by compression of the spring element wherein the linear force exceeds the known value of the spring pre-loaded plate, an output torque is determined and activates the electrical switch.

18. A method, comprising:
detecting torque measurement of a valve actuator by:
producing a linear force on a driving member by applying force from a worm drive;
measuring the linear force of the driving member with a measurement system; and
determining a torque output of the valve actuator by comparing the linear force from the worm drive with a spring constant of the spring element.

19. The method of claim 18 wherein a linear potentiometer is configured to determine the torque output.

20. The method of claim 18 wherein a microswitch is configured to determine the torque output.
